(19) United States
(12) Patent Application Publication
(10) Pub. No.: US 2021/0215480 A1
(43) Pub. Date: Jul. 15, 2021

(54) METHOD AND DEVICE FOR MEASURING THE DIMENSIONS OF THE TRANSVERSAL CROSS-SECTION OF PIPES

(71) Applicant: SICA S.P.A., Alfonsine (Ravenna) (IT)

(72) Inventor: Marco GULMINELLI, Ravenna (IT)

(21) Appl. No.: 17/272,786

(22) PCT Filed: Oct. 2, 2019
(86) PCT No.: PCT/IB2019/058386

§ 371 Date: Mar. 2, 2021

(30) Foreign Application Priority Data
Oct. 5, 2018 (IT) 102018000009209

(51) Int. Cl. G01B 21/20; G01B 21/14; G01B 11/24; G01B 17/06

(52) U.S. Cl. CPC G01B 21/20; G01B 17/06; G01B 11/2408; G01B 21/14

(57) ABSTRACT

A device for measuring the overall dimensions of the transversal cross-section of pipes made of thermoplastic material fed along a rectilinear direction, means for detecting the position, on a Cartesian plane, of four points identified on the outer surface of the pipe, the points lying on four respective half-lines originating in the origin of the Cartesian plane.

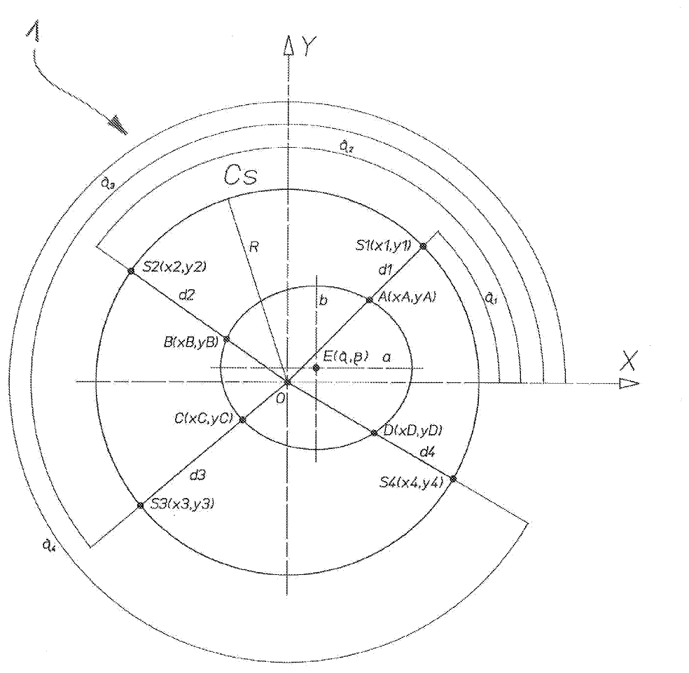

### TECHNICAL FIELD

This invention relates to a method for measuring the dimensions of the transversal cross-section of pipes.

### BACKGROUND ART

More specifically, the invention relates to a method for measuring the overall dimensions of the transversal cross-section of extruded pipes made of thermoplastic material which is also able to measure its deviation from the nominal cylindrical shape. The method according to this invention is actuated along a line for the production of pipes made of thermoplastic material.

The invention also relates to a device for measuring the overall dimensions of the transversal cross-section of pipes made of thermoplastic material.

The expression “pipes made of thermoplastic material” mainly means pipes designed for making conduits for supplying and/or draining fluids (pressurized and not), used, for example, in building works, sewers, drinking water distribution networks and in general fluids even under pressure.

The continuous measurement of the diameter of the extruded pipes made of thermoplastic material is generally useful as it makes it possible to know the quality status of the production in progress and in particular it allows the roundness characteristic of the pipe being extruded to be monitored. In fact, during the extrusion process, since it is not yet hardened, the pipe generally tends, due to the effect of its own weight, to deviate from the cylindrical shape set by the extruder and to adopt a shape with an elliptic cross-section. Reference technical standards may set a maximum permissible value of deviation from the nominal cylindrical shape. Knowing in real time the shape with an elliptic cross-section adopted by the pipe therefore makes it possible to intervene quickly to correct the undesired “out of the roundness” effect.

In addition, there are extrusion lines in which the extruding device is able to modify in real time the diameter of the extruded pipe (without stopping the extrusion process and re-activating the production line for the new diameter of pipe to be produced), in such a way as to make, in the same production line, pipes ready for different diameters within a range of diameters which is even quite large.

Clearly, in order to allow the rapid passage from one diameter to the other, the machines positioned downstream of the extruder such as fed units, cutters, belling machines, etc. should also be able to automatically reconfigure for the new diameter being produced and are for this reason “warned” of the new diameter, in such a way as to consequently start their corresponding reconfiguration.

Currently, the continuous measurement of the diameter of the pipe being extruded, with the aim of sending to the machines downstream of the extruder the signaling of variation of the diameter being produced, is normally performed by electro-mechanical devices generally having a roller with a horizontal axis, on which rests the pipe made of thermoplastic material being fed, and two rollers with vertical axes which, by means of suitable systems (elastic, pneumatic, etc), are pushed to adhere on the sides of the pipe in transit in diametrically opposite positions.

By means of suitable calibration, the reciprocal position of the two rollers with a vertical axis defines the diameter of the pipe which passes through the device.

However, the measuring device of known type described above is not free of limitations and drawbacks.

Firstly, said type of device provides only a measurement of the diameter of the pipe measured at the points of contact between the pipe and the rollers of the measuring device, without providing further information on the remaining geometry of the pipe since only the “horizontal” diameter is actually measured, unless other rollers are inserted which are not positioned vertically, but with evident complication of the device and cost increase.

If the measuring device is then used on lines which produce pipes with large diameters and/or thicknesses, for them the effect of deviation from the nominal cylindrical shape towards an elliptical cross-section shape as a result of the relative weight (as described above) and/or the poor circumferential rigidity, can be particularly accentuated.

Following this deformation there will be an incorrect reading by the measuring device which signals the presence of a pipe with a certain diameter when, on the contrary, it is, possibly, a pipe with a different nominal diameter but an elliptic deformation.

The expression “measurement of the overall dimensions of the transversal cross-section” means, in this description, both the measurement of the actual shape of the transversal cross-section (that is to say, any cross-section of the pipe perpendicular to its direction of extension and feed along the production line) and the actual numerical measurement of the cross-section.

In fact, as mentioned above, the extruded pipe does not necessarily have a perfectly cylindrical shape, but due to the typical deformations linked to its nature it adopts more generically a shape with an elliptic cross-section, although the circular cross-section shape can be identified as a particular shape of elliptic cross-section.

Generally speaking, as mentioned, the deviation from the nominal cylindrical shape will be greater the greater the diameter and thickness of the pipe and, therefore, the corresponding weight of the pipe per unit length.

### DISCLOSURE OF THE INVENTION

The aim of the invention is to provide a method and a device for measuring the dimensions of the transversal cross-section of pipes made of thermoplastic material which are free of the drawbacks of the prior art.

A further aim of the invention is to provide a method for measuring the dimensions of the transversal cross-section of pipes which is effective and practical and simple to implement.

Yet another aim of the invention is to provide a device for measuring the overall dimensions of the transversal cross-section of pipes which is simple and inexpensive to make and practical to use.

These aims and others, which are more apparent in the description which follows, are achieved, in accordance with the invention, by a measuring method and a device comprising the technical features described in one or more of the appended claims.

### BRIEF DESCRIPTION OF DRAWINGS

The technical characteristics of the invention, with reference to the above aims, are clearly described in the claims below and its advantages are apparent from the detailed description which follows, with reference to the accompanying drawing which illustrates schematically a preferred embodiment of a method for implementation of the invention.

### DETAILED DESCRIPTION OF PREFERRED EMBODIMENTS OF THE INVENTION

As illustrated in the accompanying drawing, the numeral 1 denotes in its entirety a device for measuring the overall dimensions of the transversal cross-section of pipes T made of thermoplastic material at a given instant t of the extrusion process in progress.

With reference to the accompanying drawing, a Cartesian plane OXY of axes X, Y is positioned perpendicular to a feed direction D1 of an extruded pipe T made of thermoplastic material.

The cross-section of the pipe T which at the instant t lies on the plane OXY is therefore shown in the drawing with an elliptical shape since the ellipse, due to the possible deformations to which it is subjected in the extrusion line (due to its own weight or any mechanical actions induced by containment and/or supporting rollers), is to be considered the most plausible shape which the extruded pipe can adopt.

The direction D1 is perpendicular to the plane of the drawing and, for simplicity, is indicated in the origin O of the Cartesian plane OXY.

The above-mentioned deformations to which the extruded pipe T made of thermoplastic material is subjected are mainly due to the effect of the weight force and, due to the fact that the weight force has a vertical trend, the ellipse which describes, approximately, the cross-section of the actual pipe (that is, deformed) will have the relative half-axes, respectively, one parallel and the other perpendicular to the vertical.

In light of this, the Cartesian plane has been oriented in such a way as to have the relative axis Y of the ordinates parallel to the vertical.

In this way, whatever the deformation from a circular shape to an elliptical shape, the ellipse defining the transversal cross-section of the pipe T, at the instant t lying on the Cartesian plane OXY, will have its half-axes in any case parallel to the two axes X, Y of the Cartesian plane OXY.

Again with reference to the accompanying drawing, four optical sensors S1, S2, S3, S4 are positioned along half-lines which originate in the origin O of the Cartesian plane OXY and lie on the same plane.

The optical sensors S1, S2, S3, S4 are advantageously of the laser type.

The optical sensors S1, S2, S3, S4 are configured and oriented in such a way as to perform the relative measurements along the corresponding half-lines, identifying the respective distances d1, d2, d3, d4 at which there are the intersection points A, B, C, D of the outer surface of the pipe T with each half-line at the instant t.

For each optical sensor S1, S2, S3, S4, knowing the source position through the respective positioning coordinates (x1, y1), (x2, y2), (x3, y3), (x4, y4) in the Cartesian plane OXY (not superposed) and after acquiring the respective distances d1, d2, d3, d4 (measured by the sensors), the coordinates (xA, yA), (xB, yB), (xC, yC), (xD, yD) of the four points A, B, C, D in the plane OXY are consequently derived.

The above-mentioned half-lines define respective angles α1, α2, α3, α4 with the axis X of the X-axis of the Cartesian plane.

The above-mentioned half-lines each lie preferably, but not necessarily, on a respective different quadrant of the Cartesian plane OXY.

In general, for the purpose of the existence of coherent solutions of the system of equations which will be described below, at most three of the half-lines may be bisectors of the quadrants of the plane OXY.

The condition just specified constitutes a condition which it is necessary to satisfy to allow the resolution of the above-mentioned equation system.

In more general terms, the above-mentioned angles α1, α2, α3, α4 are therefore separate from each other with at most three of them equal to 45°+k=90° with k=0, 1, 2, 3, the angles being measured in an anticlockwise direction starting from the positive axis X of the Cartesian plane OXY.

With reference, by way of example, to the case illustrated in the drawing, by measuring the angles in an anticlockwise direction starting from the positive axis X, α1=45°, α2=145°, α3=220°, α4=330°.

Advantageously, the optical sensors S1, S2, S3, S4 are then positioned along a circumference Cs, the centre of which is located in the origin O of the Cartesian plane OXY.

In this way, the distance of each optical sensor S1, S2, S3, S4 from the origin O of the Cartesian plane is the same.

The above-mentioned optical sensors S1, S2, S3, S4 define, for the measuring device 1, respective means for measuring the position, on a Cartesian plane, of the four points A, B, C, D identified on the outer surface of the pipe T.

According to alternative embodiments of the invention not described further, the above-mentioned position measurement means comprise sensors of different types, such as, for example, ultrasound sensors.

The device 1 also comprises, not illustrated, a processing unit configured for calculating the equation of the ellipse lying in the plane OXY and passing through the four separate points A, B, C, D (the position of which is identified by the optical sensors S1, S2, S3, S4), with the half-axes parallel to the respective Cartesian axes of the plane OXY.

After calculating in this way the equation of the ellipse, the processing unit then obtains the coordinates of its centre in the Cartesian plane OXY and the values of the half-axes a and b of the ellipse and from them the average diameter and the relative eccentricity.

Assuming, as mentioned, that the most plausible shape which the extruded T pipe can adopt is that with an elliptical cross-section, then the general equation is considered of an ellipse simply translated in the plane:

$$\frac{{( x - α )}^{2}}{{a}^{2}} + \frac{{( y - β )}^{2}}{{b}^{2}} = 1$$

where E(α, β) indicates the centre of the ellipse and a and b indicate the larger and smaller half-axes, respectively, parallel to the axes of the OXY plane. Given:

$$\{ \begin{matrix}p = {a}^{2} \\ q = {b}^{2}\end{matrix}$$

it is possible to rewrite the equation as follows:

$$\frac{{( α - x )}^{2}}{p} + \frac{{( β - y )}^{2}}{q} = 1$$

which is equivalent to:

q(α−x)²+p(β−y)²=pq

With reference to the drawing, assuming the four sensors S1, S2, S3, S4 on the circumference Cs with centre O and radius R in such a way that the respective angles α1, α2, α3, α4 formed by the half-lines with the positive axis of the X-axis are different from each other and satisfy the above-mentioned necessary condition.

The radius R of the circumference Cs is such as to contain the maximum nominal diameter of the pipe T which may be extruded in the production line on which the measuring device 1 is installed.

Therefore, in the specific example illustrated, α1≠α2≠α3≠α4 with only α1 in the form 45°+k=90°, with k=0.

By indicating as mentioned with A, B, C, D, the four separate measuring points on the outer surface of the pipe, that is to say, the points identified by the optical sensors S1, S2, S3, S4, the distance of which from the sensors has been measured by them, they are defined as follows:

$$\{ \begin{matrix}A ( xA , yA ) = ( x 1 - d 1 cos α1 , y 1 - d 1 sen α 1 ) \\ B ( xB , yB ) = ( x 2 - d 2 cos α2 , y 2 - d 2 sen α 2 ) \\ C ( xC , yC ) = ( x 3 - d 3 cos α3 , y 3 - d 3 sen α 3 ) \\ D ( xD , yD ) = ( x 4 - d 4 cos α4 , y 4 - d 4 sen α 4 )\end{matrix}$$

In order to determine the four unknowns α, β, p, q, the ellipse is set to pass through the four points A, B, C, D, thus obtaining the following system s1:

$$( s1 ) \{ \begin{matrix}{q ( α - xA )}^{2} + {p ( β - yA )}^{2} = pq ( 1 ) \\ {q ( α - xB )}^{2} + {p ( β - yB )}^{2} = pq ( 2 ) \\ {q ( α - xC )}^{2} + {p ( β - yC )}^{2} = pq ( 3 ) \\ {q ( α - xD )}^{2} + {p ( β - yD )}^{2} = pq ( 4 )\end{matrix}$$

Subtracting the equation (2) from (1) gives:

q[(α−xA)²−(α−xB)²]+p[(β−yA)²−(β−yB)²]=0

from which, after a few steps:

(yA²−yB²)p+(xA²−xB²)q−2(xA−xB)αq−2(yA−yB)βp=0

Now given:

$$\{ \begin{matrix}α q = u \\ β p = v\end{matrix}$$

the following is obtained:

(yA²−yB²)p+(xA²−xB²)q−2(xA−xB)u−2(yA−yB)v=0

Similarly, subtracting the equation (3) from (1) and subtracting the equation (4) from (1) we obtain the following system:

$$\{ \begin{matrix}( {yA}^{2} - {yB}^{2} ) p + ( {xA}^{2} - {x B}^{2} ) q - 2 ( xA - xB ) u - 2 ( yA - yB ) v = 0 \\ ( {yA}^{2} - {yC}^{2} ) p + ( {xA}^{2} - {xC}^{2} ) q - 2 ( xA - xC ) u - 2 ( yA - yC ) v = 0 \\ ( {yA}^{2} - {yD}^{2} ) p + ( {xA}^{2} - {xD}^{2} ) q - 2 ( xA - xD ) u - 2 ( yA - yD ) v = 0\end{matrix}$$

The system described above makes it possible to express p, q, and u, and, consequently, also α and β, as a function of v.

By replacing the values obtained in any of the equations of the system s1, it is possible to determine v and therefore the values of p, q, α and β.

In this way, by means of simple operations performed by the above-mentioned and not illustrated processing unit, all the characteristic values of the ellipse are obtained which approximate the shape of the pipe T in cross-section at the generic instant t, that is to say, mainly the values of the larger and smaller half-axes a, b, respectively.

From the values of the half-axes the processing unit is configured to obtain the average diameter of the pipe T as (a+b)/2 and the relative eccentricity, in terms of the maximum deviation between the nominal diameter Dn which the pipe being extruded should have and the maximum between the absolute values of the two differences [Dn−a] and [Dn−b].

By means of the method and the device according to the invention it is therefore possible to continuously estimate both the overall dimensions of the pipe T (in terms of average diameter) and its deformation relative to the ideal circumference, thus allowing the machines downstream of the extruder to be informed with in a precise manner regarding the status of variation in progress of the pipe produced in the production lines which require it, as well as allowing it to be known immediately whether and to what extent the pipe is deviating from the expected theoretical cylindrical shape. An advantage linked to the invention is due to the fact that it is irrelevant, for the purposes of assessing the cross-section of the pipe T, whether the centre E of the ellipse, and therefore of the pipe T, lie on the direction D1 passing through the origin O of the Cartesian plane OXY.

In other words, the axis of the device (shown by the perpendicular to the plane OXY passing through O) may not be perfectly centered on the axis of the pipe T in transit, without this affecting the correct determination of the ellipse which approximates the cross-section of the pipe T, unlike the usual devices which require, for a correct measurement, an excellent alignment between the axis of the pipe T and the axis of the device.

Alternative embodiments of this invention, although less advantageous than that described above, may comprise, as position detection means, mechanical contact members in physical contact with the surface of the pipe T in transit and the relative position of which is measured with linear or rotary potentiometers or encoders.

According to a variant embodiment of the invention, not illustrated, there are more than four distance measuring sensors. More specifically, for example, the presence of five sensors allows the identification of an ellipse in the Cartesian plane OXY even when this does not have the relative half-axes parallel to the axes of the Cartesian plane.

1. A method for measuring the dimensions of the transversal cross-section of a pipe made of thermoplastic material fed along a rectilinear direction, comprising the steps of:
defining a Cartesian plane having its origin inside the transversal cross-section of the pipe to be measured and being substantially perpendicular to the rectilinear direction of feeding the pipe,
preparing outside the pipe four distance measuring sensors along respective half-lines originating from the origin of the Cartesian plane, each of the half-lines forming, with the axis of the X-axis of the Cartesian plane, respective angles which are separate from each other,
measuring the distance of each of the sensors from the outer surface of the pipe, the distance being measured along the half-lines to define the coordinates on the Cartesian plane of the intersection points of the half-lines with the outer surface of the pipe,
calculating the equation of the ellipse passing through the intersection points, thereby defining the shape and the position of the pipe relative to the sensors and to the Cartesian plane.

2. The method according to claim 1, wherein the step of preparing the sensors along respective half-lines comprises the step of selecting the half-lines in such a way to respect the condition by which at the most three of the half-lines constitute bisectors of respective quadrants of the Cartesian plane.

3. The method according to claim 1, wherein the step of preparing the sensors comprises the step of positioning the sensors along a circumference having the centre in the origin of the Cartesian plane.

4. A device for measuring the dimensions of the transversal cross-section of pipes made of thermoplastic material fed along a rectilinear direction, comprising:
means for detecting the position, on a Cartesian plane, of four points identified on the outer surface of the pipe, the points being separate from each other and lying on four respective half-lines originating in the origin of the Cartesian plane,
a processing unit configured for calculating the equation of the ellipse passing through the four points the position of which is identified by the detection means.

5. The device according to claim 4, wherein the position detection means comprise four distance measurement sensors positioned outside the pipe along the half-lines originating from the origin of the Cartesian plane.

6. The device according to claim 5, wherein the distance measurement sensors are optical sensors.

7. The device according to claim 5, wherein the distance measurement sensors are ultrasound sensors.

8. The device according to claim 4, wherein the half-lines are such as to respect the condition by which at the most three of the half-lines constitute the bisectors of respective quadrants of the Cartesian plane.
